(19) United States
(12) Patent Application Publication
(10) Pub. No.: US 2021/0319372 A1
(43) Pub. Date: Oct. 14, 2021

(54) ONTOLOGICALLY-DRIVEN BUSINESS MODEL SYSTEM AND METHOD

(71) Applicant: Meaningful Technology Limited, Auckland (NZ)

(72) Inventors: Dougal Alexander WATT, Westmere Auckland (NZ); Matthew Mehdi Jamshidkhani CLAYTON, Auckland (NZ); Stefan Gary PRESTON, Ponsonby Auckland (NZ)

(21) Appl. No.: 17/267,690

(22) PCT Filed: Aug. 8, 2019
(86) PCT No.: PCT/NZ2019/050094

§ 371 Date: Feb. 10, 2021

(30) Foreign Application Priority Data
Aug. 10, 2018 (NZ) 745176

(51) Int. Cl. G06Q 10/06; G06F 16/21

(52) U.S. Cl. CPC G06Q 10/067; G06F 16/212; G06Q 10/0637

(57) ABSTRACT

A method and system for designing, building and operating a business model for a business on an electronic computing device is described. The system and method including creating an ontology of the elements and links representative of the business model; creating a declarative specification of these schema via deployment of hardware and software configurations, realising this specification through deployment into a cloud system; and creating an operational interface and displaying the operational interface to allow a user to operate the business.

### FIELD

This invention relates to business models and systems and methods for implementing business model.

### BACKGROUND

A business model (BM) is a structured definition of the purpose of a business, what it does, and how it operates. Osterwalder et al. (2004) summed up academic work on BMs from the past 20 years and stated that a definition of a BM broadly relates to a blueprint of how a business should conduct its business (Osterwalder, Pigneur, & Tucci, 2005). They further argue that a BM is a set of elements, which can be referred to as building blocks that, by their interrelation, express the logic of how a business earns money (Osterwalder, Pigneur, & Tucci, 2005).

Most businesses operate with an assumed business model—i.e. the business model has not been consciously designed, rather has evolved over time in response to many factors such as founder/owner desires, market responses, and available resources.

Recently, business owners are increasingly discussing how to plan and design a business model as a discrete activity before starting a business, or to evolve a current business, in contrast to the earlier approach of organically evolving the business model. This desire to design a business model has recently accelerated with the advent of exponential business models such as Uber and Facebook, whereby owners consciously design a business to have desired exponential attributes before starting the business in order to achieve massive levels of scale, high repeatable profitability and zero marginal cost. Exponential attributes include user self-provisioning, leverage of algorithms including Al to manage resource allocation and leverage of social technologies to promote crowdsourcing methods.

Conscious creation of a business according to a business model requires a framework to define the different ‘inner working’ elements of a business model, and tools to turn these elements into an executable business.

Business Model Frameworks

A variety of formal business model frameworks have evolved and are widely discussed in literature e.g. Burkhart, Thomas & Krumeich, Julian & Werth, Dirk & Loos, Peter. (2011). “Analysing the Business Model Concept—A Comprehensive Classification of Literature. International Conference on Information Systems 2011, ICIS 2011. 5”. The authors analysed 30 frameworks and identified a range of weaknesses including a lack of visual representations of business models (found in only 3 models), which should be necessary to enable widespread understanding and adoption by business owners/designers and is one of the subjects of this invention.

More recent frameworks have started to include visual depictions of business models. For example, the Business Model Cube (Peter Lindgren, 2013) 101 summarized previous research and extracted common elements of existing frameworks to create a ‘cube’ representation as seen in FIG. 1. Other notable examples of visual representations of business model frameworks include the Enterprise Business Motivation Model by Nicklas Malik (motivationmodel.com/ebmm/) 201 seen in FIGS. 2A-2D and the Business Model Canvas (alexosterwalder.com) 301 seen in FIG. 3.

While these frameworks provide visual representations that aid business owners in understanding the structure of a business model, they still suffer issues that significantly limit their utility. These include:
1. Complexity—each framework has a moderate to high level of complexity, which limits the ability of most users to understand the business model elements described in the framework.
2. Limited guidance—many frameworks have limited guidance for business owners to create their own business model. The most complete set of guidance exists for the Business Model Canvas, however the utility of this is still questionable due to the third limitation.
3. Execution—all frameworks are designed for creating a model of the business, not actually turning that model into an executable business that can trade.

### Business Model Tools

Although business model frameworks have been in existence for more than a decade, software tools (apps) that implement these frameworks are almost non-existent. In addition, they also typically conflate concepts of business model, strategy and tactics, resulting in products that provide little or no coverage of business model frameworks, and can't be used to design and implement a business model.

The Strategyzer app (strategyzer.com) was developed by the author of the Business Model Canvas framework to assist business owners to fill in the boxes of the Business Model Canvas, and explore scenarios for their business design, but it does not allow the owner to actually instantiate the business as an operational entity capable of trading. A range of knock-off apps also exist (e.g. canvanizer.com) that simply copy the Business Model Canvas and provide additional training content.

Searches online via app marketplaces and review sites (e.g. captera.com; getapp.com; whatasoftware.com) also show a very limited set of categories of app tools exist that focus on the strategic and tactical/operational levels of implementing businesses, and don't let users explicitly design their business model. Typical categories include:
Business planning
Strategic planning
Balanced scorecard
Business tracking
Product design and management
Business performance management
Business process management

Business planning tools are designed for the creation of business plans, consisting of a limited set of elements from business model frameworks, such as vision/mission statements, markets & customers, and some financial planning functionality. Similarly, the Strategy planning tools are functionally equivalent to the business planning tools, but typically lack the financial management aspects of business planning tools. Both types of tools operate at a level below the business model, which sets the overall business direction these operate within. The remaining categories deal only with limited aspects of business operations, not business models.

No solutions are currently available to design a business model, build solutions to the design of this model, and operate the business daily. It is an object of the invention to provide an improved business model system and method or to at least provide the public or industry with a useful choice.

### SUMMARY

According to one example embodiment there is provided a method of designing, building and operating a business model for a business on an electronic computing device comprising the steps of:
receiving and storing a plurality of elements including
   entities that participate in the business;
   activities that are performed by users or applications;
   assets of the business, including applications and algorithms,
wherein the application assets are linked with activities and information; and
   algorithms that are linked with information; and
   information to be accessed and processed by activities and assets;
receiving and storing links between the elements;
creating an ontology of the elements and links representative of the business model;
creating a plurality of schema representative of the business model, the plurality of schema including:
   an information schema that describes the information that flows through the activities;
   a constraints schema;
   a workflow schema representative of the activities;
   an application schema representative of the applications; and
   an algorithm schema;
   an environment schema;
   an integration schema;
storing the plurality of schema in a graph database;
creating an activity workflow from the workflow schema;
creating application integrations using the information and application schemas;
creating a plurality of algorithms from the algorithm schema for the operation of the business model;
creating a declarative specification of these schema via deployment of hardware and software configurations
realising this specification through deployment into a cloud system
creating an operational interface and displaying the operational interface to allow a user to operate the business.

Preferably the information schema describes the information that flows through the activities from integrations and algorithms, and may or may not contain additional processed representations of the information for the purpose of analysis of the business model

Preferably the entities that participate in the business include business users, partners, suppliers, and participants in value chains/networks.

Preferably activities include any arbitrarily complex business process, value chain, resource and/or capability definition as sets of manual and/or automated activities.

Preferably activities create and consume information.

Preferably the assets include physical and digital assets.

Preferably digital assets provide automation to the business model through technology and include applications used to deliver the activities.

Preferably algorithms provide user defined business rules to the business model through consumption, computation according to defined rules and resulting output of new information.

Preferably the information has constraints which restricts the structure and meaning of an information.

Preferably the constraints are stored as information.

According to a further example embodiment there is provided a system for designing, building and operating a business model for a business the system including:
at least one processor;
memory associated with the processor; and a display device;
wherein the processor is programmed to perform the steps of:
   receiving and storing a plurality of elements including
      entities that participate in the business;
      activities that are performed by users or applications;
      assets of the business, wherein the assets are linked with activities; and
      information to be accessed and processed by activities;
   receiving and storing links between the elements;
   creating an ontology of the elements and links representative of the business model;
   creating a plurality of schema representative of the business model, the plurality of schema including:
      an information schema that describes the information that flows through the activities;
      a constraints schema;
      a workflow schema representative of the activities;
      an application schema representative of the applications; and
      an algorithm schema representative of the business rules;
      an environment schema representative of the physical deployment of the business model;
   storing the plurality of schema in a graph database;
   creating an activity workflow from the workflow schema;
   creating application integrations using the information and application schemas and user defined mappings between these;
   creating a plurality of algorithms from the algorithm schema for the business rules of the business model;
   creating a physical deployment specification for the operation of the business model from the environment schema;
   creating an operational interface and displaying the operational interface to allow a user to operate the business.

Preferably the entities that participate in the business include business users, partners, suppliers, and participants in value chains/networks.

Preferably activities include any arbitrarily complex business process, value chain, resource and/or capability definition as sets of manual and/or automated activities.

Preferably activities create and consume information.

Preferably the assets include physical and digital assets.

Preferably digital assets provide automation to the business model through technology and include applications used to deliver the activities and algorithms used to compute business rules.

Preferably the information has constraints which restricts the structure and meaning of information.

Preferably the constraints are stored as information.

Preferably the physical network and server hardware resources required to operate the business are specified and controlled using a declarative specification and mapping of the business model elements onto common hardware and software systems.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of a cube business model framework;

FIG. 2A is a diagram of the Enterprise Business Motivation Model;

FIG. 2B is a first partial view of the diagram of FIG. 2A;

FIG. 2C is a second partial view of the diagram of FIG. 2A;

FIG. 2D is a third partial view of the diagram of FIG. 2A;

FIG. 3 is a diagram of the Business Model Canvas;

FIG. 4 is a diagram of an embodiment of the business model elements;

FIG. 5 is a diagram of the set of steps orchestrating the implementation mechanism in FIG. 6, in accordance with embodiments of the present invention;

FIG. 6 is a detailed internal view of the implementation mechanism in accordance with embodiments of the present invention;

FIG. 7 is a business model of an example business;

FIG. 8 is a business model of an example business after integrating another business;

FIG. 9 is a text view ontology of an example business;

FIG. 10 is a graph view ontology of an example business;

FIG. 11 is a text view of the algorithm schema of an example business showing an example Actuarial Service algorithm;

FIG. 12 is a text view of the application schema of an example business showing an API and data;

FIG. 13 is a text view of the constraint schema of an example business showing example constraints;

FIG. 14 is a text view of the environment schema of an example business showing the deployment manager;

FIG. 15 is a text view of the information schema of an example business showing the business information;

FIG. 16 is and entity relationship diagram of an example business;

FIG. 17 is a text view of the integration schema of an example business showing a refinement of the data integration; and

FIG. 18 is a text view of the role schema of an example business showing business roles.

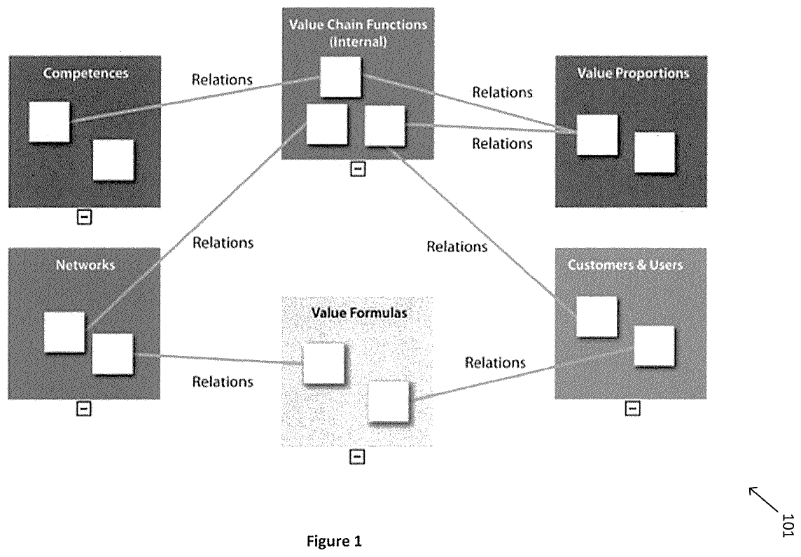

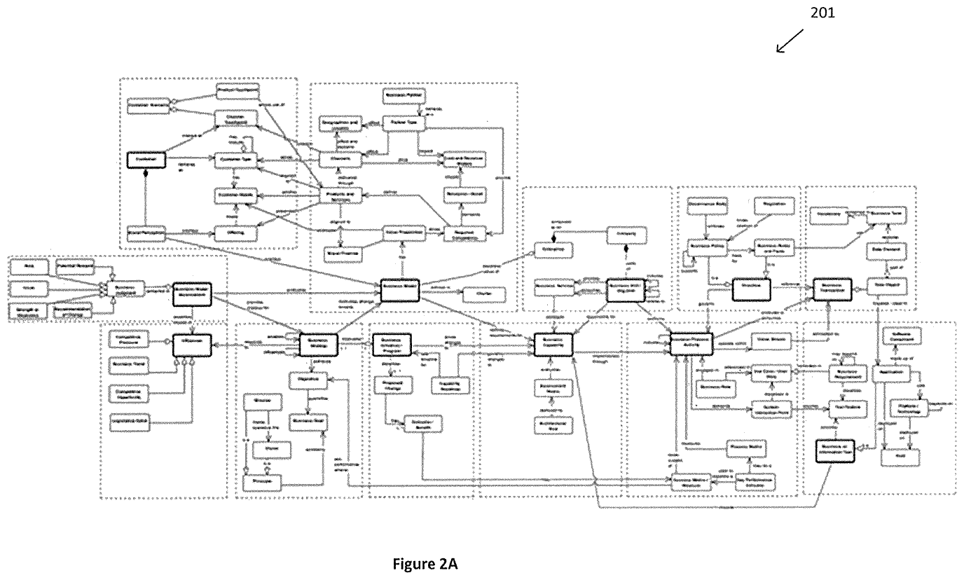

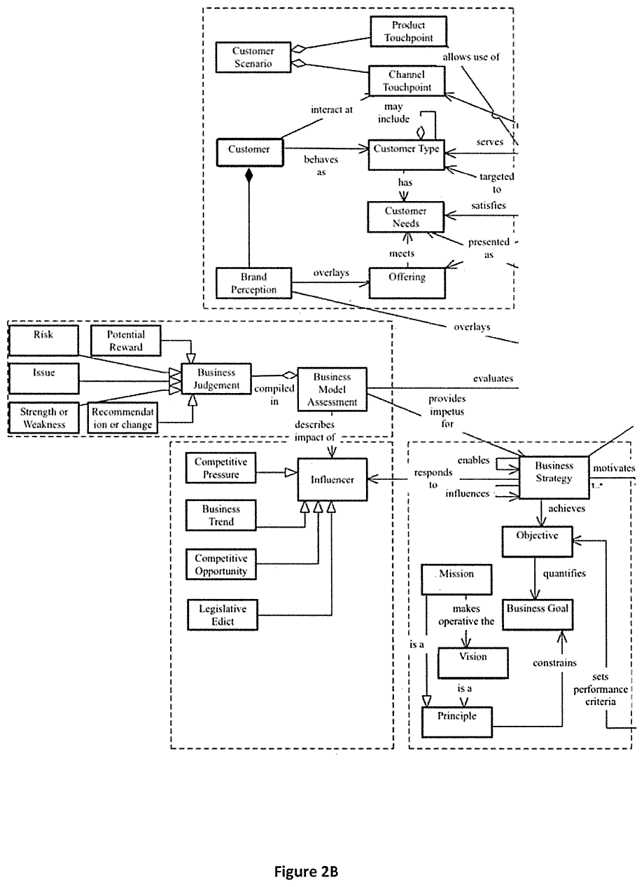

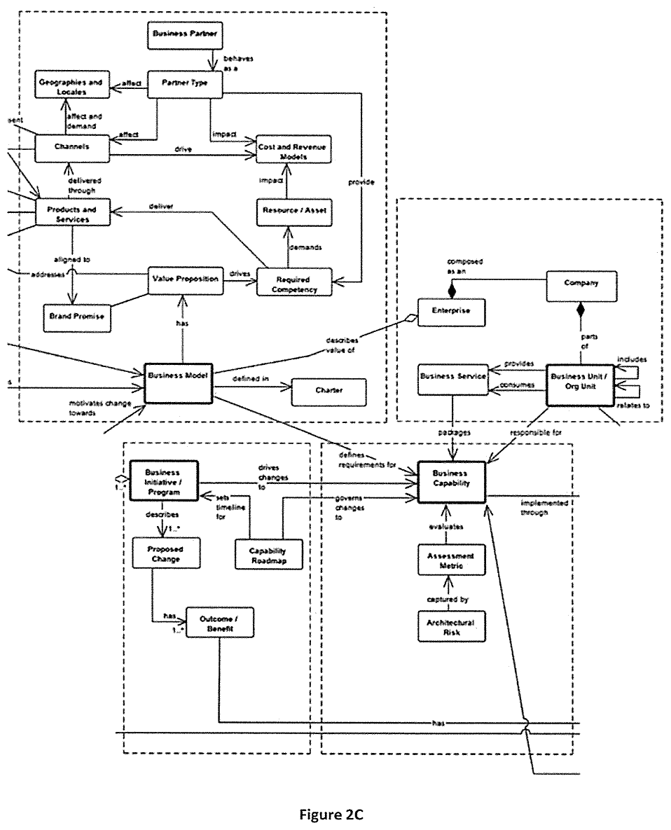

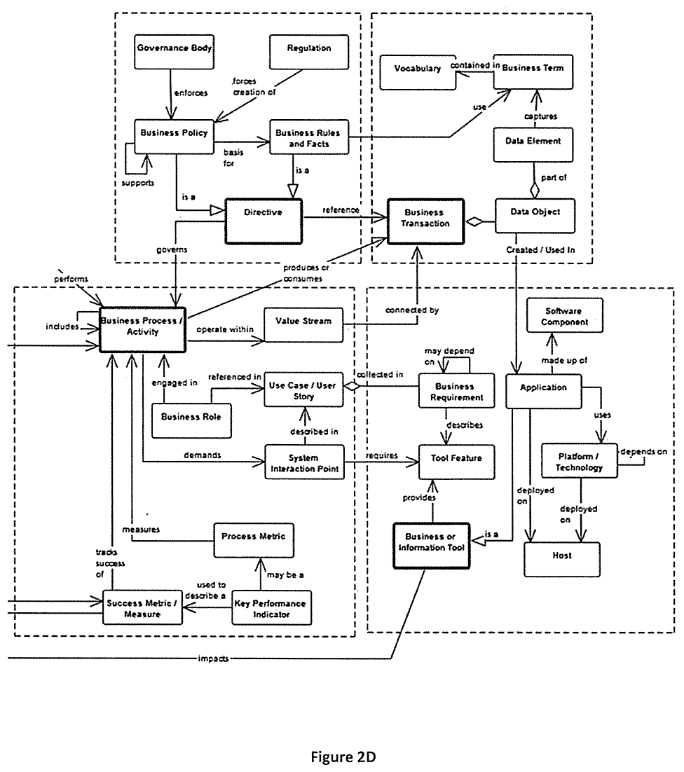

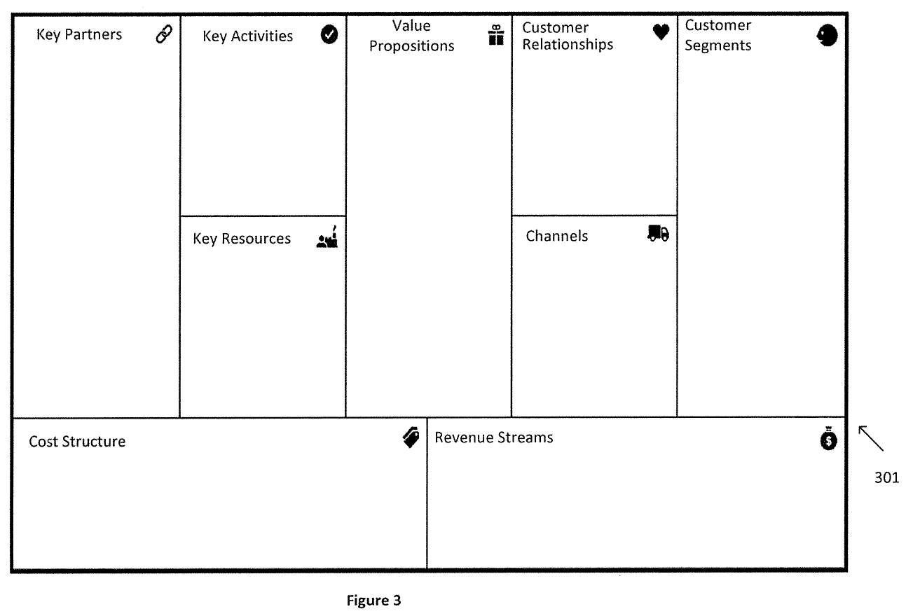

### DETAILED DESCRIPTION

The above discussion shows that all current business model frameworks suffer from a number of limitations that restrict their utility for business owners. They represent an idealized, often highly complex, view of a business that is abstracted from the real-world experience of most business owners. They provide little or no guidance and assistance for a business owner in designing and establishing a business, or in modifying an existing business towards a new model. They also lack practical tooling that is usable by people who are unfamiliar with the different frameworks.

To resolve these issues, this invention proposes a new Method and System that has been developed to overcome these problems. The system guides a business owner through designing their business model, and then creates the software and information structures necessary to support the business model and provides mechanisms for the user to operate the business.

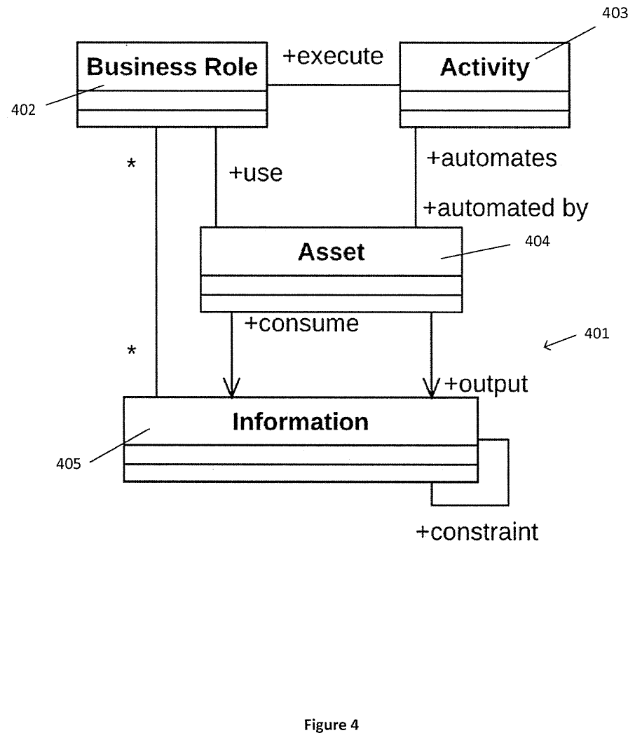

The model is comprised of a business model framework consisting of four business model elements, and a computer system that manages the design, build, and operation of business models constructed in accordance with this framework. This framework 401 is depicted in FIG. 4.

### Business Role

This element 402 represents business users, partners, suppliers, and participants in value chains/networks etc. as a set of key roles that participate in the business model. Business users can be internal to the business, or external to the business as customers or suppliers/partners.

### Activity

This element 403 represents collections of activities that will be performed by users or applications, as part of the business model design. This element allows the user to create any arbitrarily complex business process, value chain, resource/capability definition as sets of manual and/or automated activities. Activities can be associated to one or more Asset elements that will automate the activities.

### Asset

This element 404 represents the physical and digital assets that the business requires to operate the business model. Physical assets can include for example, buildings, machinery, land, raw materials etc. Physical assets can be represented in the system as information that is fed by physical asset management systems, or alternatively via an Application that provides asset management services. Digital assets are responsible for providing automation to the business model through technology and include applications (apps) that are used to deliver the activities element, digital channels such as email, voice, internet etc, and algorithms that use information to produce insight required to make decisions (automated or manual via roles), or to create business computations such as value and profit formula. Algorithms consume information and output information, typically via applications.

### Information

This element 405 represents the information that the business model must manage. Information is typically accessed via one or more applications and is both input and output to algorithms. Activities also create and consume information, typically via Applications that are automating the activity, and/or information input by users to said Applications. Information may also have Constraints applied to it, which restricts the structure and meaning of an information item. Constraints are themselves expressed as an information representation, and the Constraints Service component provided by the system enforces these. Information may also be further processed in accordance with additional information schema to create summarised representations for use in the analysis of said information.

### Relationships

This element is shown in FIG. 4 as the set of links between elements. A basic set of relationships are shown in this diagram, but additional relationships are supported by the system. For example, a ‘Business Analyst’ Business User may have an ‘analyse’ relationship to Information as they are using business information to analyse the performance of the business, while a ‘Warehouse Worker’ Business User may have a ‘create stock location’ relationship to the ‘inventory’ Information type.

These elements were selected, as they are common underlying ‘business model primitives’ that can be used to represent all higher-level elements in common business model frameworks (see Table 1 below).

TABLE 1
Mapping of the system business model framework elements to common
business model frameworks:
The system uses these business model elements in a repeatable method, or sequence of
activities and structured artefacts, to place, link, group, and annotate these elements on
a drawing canvas, such that the created visual model represents the business model the
user wishes to create.

| | | | Primitive Business |
|---|---|---|---|
| Framework | Element | Description | Model Element |
| Business Model | Value proposition | Products | Information; Asset |
| Cube | | Services | Information |
| | | Processes | Activity; Asset |
| | Customer and or | Target users | Business Role |
| | User | Customers | Business Role |
| | | Market segments the business | Information |
| | | serves | |
| | Value Chain | Physical, virtual, digital | Information |
| | Functions | | |
| | Competence | Assets | Asset |
| | | Processes | Activity |
| | | Activities that translate business | Activity; Asset |
| | | inputs into customer value | |
| | Network | Network and network partners, | Business Role; |
| | | strategic partners, suppliers etc | Information |
| | Relations | Physical, virtual, digital relations | Information |
| | Value formulae | Profit & value formula | Asset |
| Four box | Customer value | Products, services, processes | Information; Asset |
| (Johnson 2010) | proposition | | |
| | Profit formula | Profit formula | Asset |
| | Key resources | What are the required resources? | Asset |
| | Key processes | Processes | Activity |
| Six function | Value proposition | The value created for users by the | Information; Asset |
| (Chesborough & | | offering based on the technology | |
| Rosenbloom, 2002) | Market segment | The users to whom the technology | Business Role |
| | | is useful and for what purpose | |
| | Value chain | Structure of the value chain within | Information; |
| | | the firm required to create and | Activity |
| | | distribute the offering | |
| | Cost structure/profit | The cost structure and profit | Information; |
| | potential | potential of producing the offering, | Algorithm |
| | | given the value proposition and | |
| | | value chain structure chosen | |
| | Value network | The position of the firm within the | Information; |
| | | value network linking suppliers and | Business Role |
| | | customers, | |
| | | including identification of potential | |
| | | complementors and competitors | |
| | Competitive strategy | The competitive strategy by which | Information |
| | | the innovating firm will gain and | |
| | | hold advantage over rivals | |
| Four factor | Importance of the | Expressed as an underlying job-to- | Information |
| (Muegge, 2012) | customer “pain point” | be-done, a problem-to-be-solved, | |
| | | or an unmet need | |
| | Stakeholder value | Identifies the critical-to-success | Information |
| | propositions | stakeholder group and articulating | |
| | | a compelling value proposition for each | |
| | Profit formula | explanation of the revenues | Information; Asset |
| | | and costs of delivering on the SVPs, | |
| | | and an explanation of why revenues | |
| | | exceed costs in a way that produces | |
| | | attractive profits | |
| | Capabilities | The critical to success capabilities | Information; |
| | | needed to deliver on the SVPs while | Activity; Asset; |
| | | earning attractive profits, and an | Business Role |
| | | explanation of how the firm will | |
| | | obtain access to those capabilities | |
| | | or prevent access by rivals | |
| Business Model | Customer segments | How to segment market | Business Role |
| Canvas | Value propositions | Value delivered to customers; | Information |
| (Osterwalder & | | problems solved; jobs done; | |
| Pigneur, 2010) | | products/services per segment | |
| | Channels | How to reach customers | Information; Asset |
| | Customer | How to acquire, keep, grow | Information; Asset |
| | relationships | customer base | |
| | Revenue streams | What revenue streams do you have, | Information |
| | | and how streams much does each | |
| | | stream contribute? | |
| | Key resources | What are the required resources? | Information; |
| | | | Activity; Asset; |
| | | | Business Role |
| | Key activities | What are the requires activities? | Activity |
| | Key partnerships | Who are the key suppliers and | Business Role |
| | | partners | |
| | Cost structure | What are your most important | Information |
| | | costs? Which activities/resources | |
| | | are most expensive? Is your | |
| | | business model cost- or value- | |
| | | driven? | |

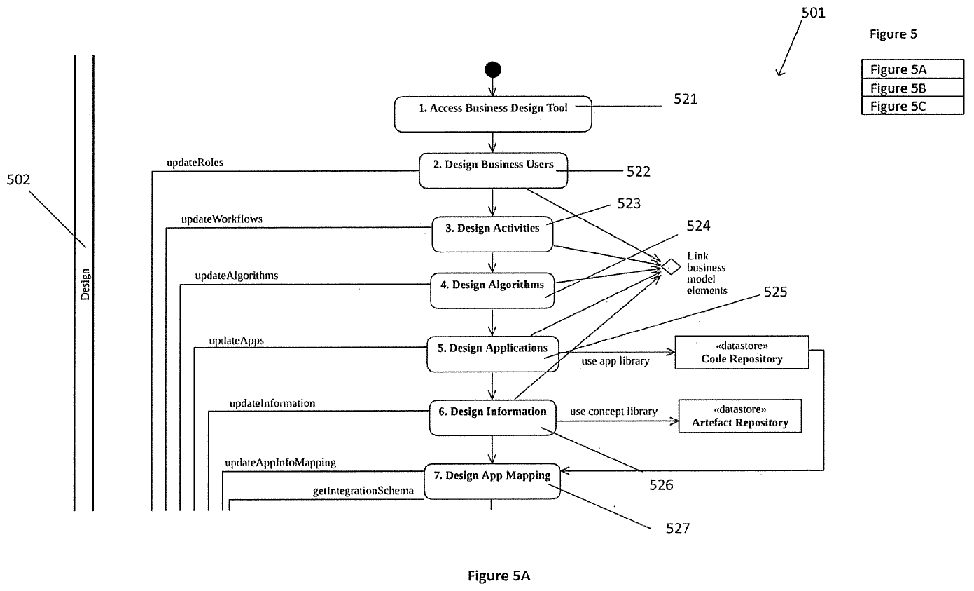

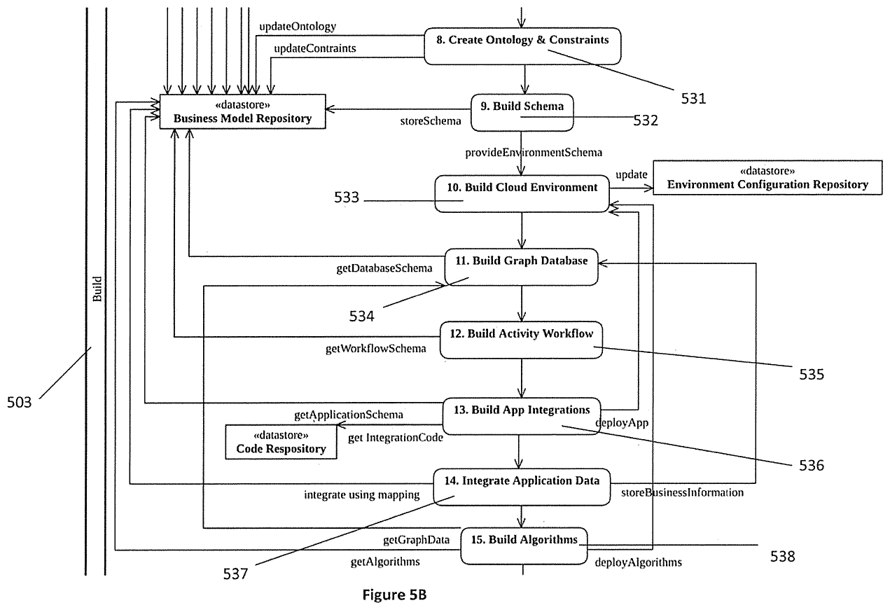

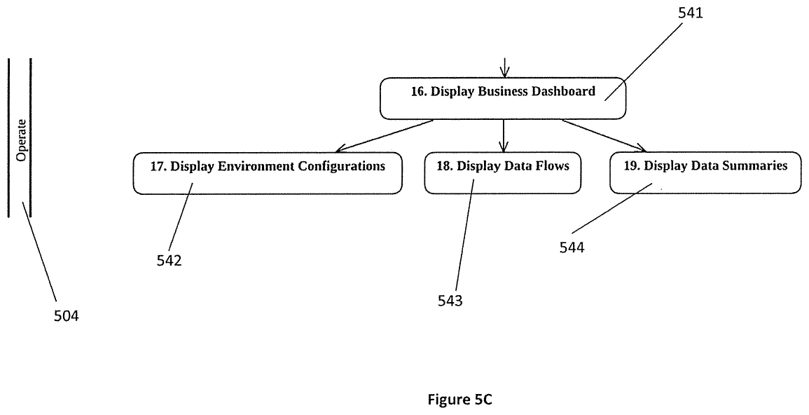

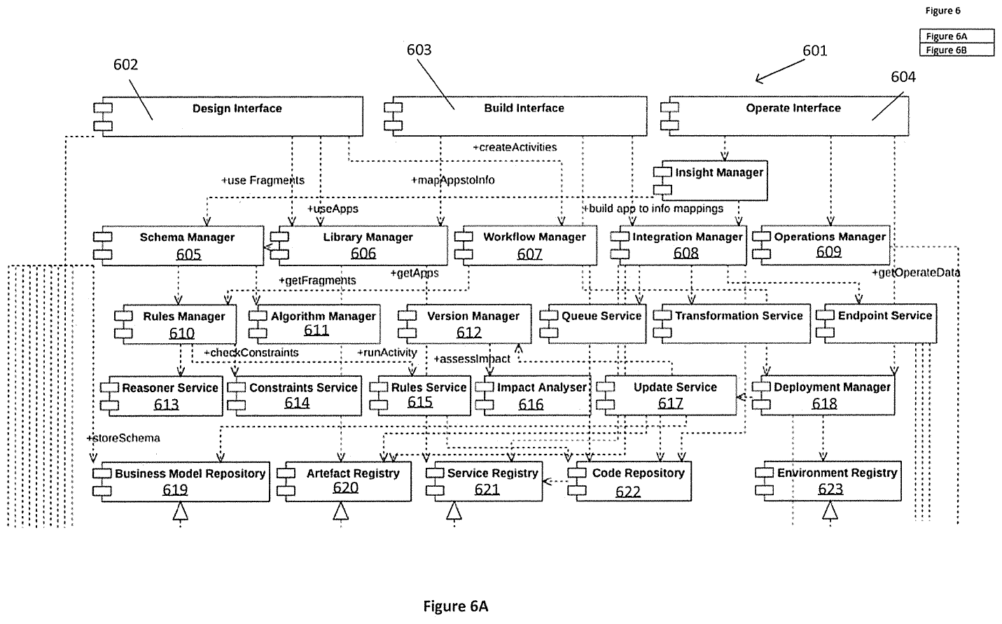

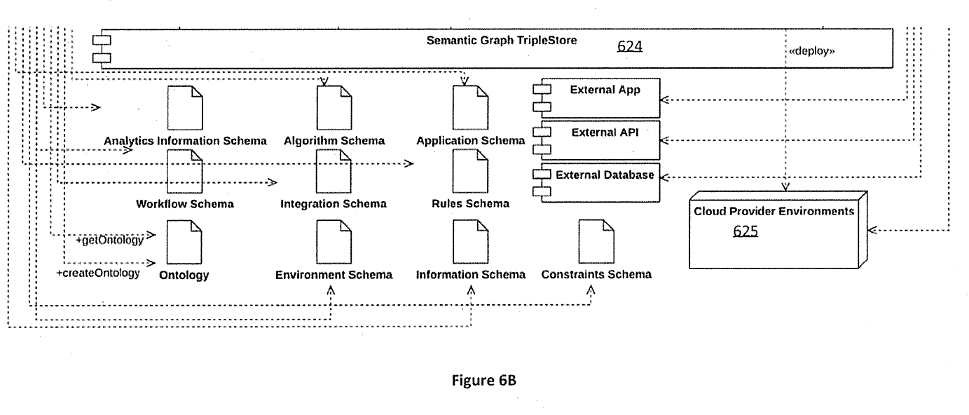

Use of these primitive elements allows construction of an arbitrarily complex business model with minimal confusion, maximal reuse, and high degree of automation. This occurs across three phases as depicted 501 in FIG. 5, and uses the detailed internal view 601 of the implementation mechanism depicted in FIG. 6.

### Design Phase

### 1. Access Business Design Tool

The user accesses 521 the interface provided by the system, to design 502 their business model, and selects icons from a palette that correspond to the business model framework elements. Additional palettes and windows provide further options to flesh out these business model elements, such as specifying the internal structure of the business model elements and rules that may apply to these elements, as described in the following steps.

### 2. Design Business Users

The user designs 522 the Business User element of their business model by specifying role names, whether they are internal or external to the business, and a description of the roles. One created, the user can associate a business user to other elements of the business model design. For example, the user can link a Business User to a set of activities, applications and information that represent the work that user will perform as part of the business model.

### 3. Design Activities

The user designs the Activity element 523 of their business model by specifying collections of activities that will be performed by business users as part of the business model design. A window allows the user to specify the name of the activity, and internal details such as activity steps and rules for the element. This element allows the user to create any arbitrarily complex business process, value chain, resource/capability definition as sets of activities. Once created, the user can associate an activity element to other elements of the business model design. For example, to specify how activities are automated the user can associate the activity or group of activities to one or more application Asset elements that will supply the required activities.

### 4. Design Algorithms

The user designs the Algorithm element 524 of their business model by specifying the internal details of the algorithm associated with business computations such as value and profit formula, and analytics activities that must be run to provide insight for the business. The system provides one or more implementations of algorithm languages such as the R data programming language via an Algorithm Manager component. Once created, the user can associate an algorithm element to other elements of the business model design, such as applications that will provide the required computation or analytics capabilities, or to specific activity steps requiring computation.

### 5. Design Applications

The user designs the Applications Asset element 525 of their business model by specifying the applications that will provide automation in the business model for processes or activities, or by providing channels for business users to interact with (e.g. voice, chat, internet). A window allows the user four approaches to designing the application element of their business model.

First, they can specify the name or type of application they wish to include (e.g. Customer Relationship Management app to manage customer information) and defer selecting an appropriate application for their specified type until later, using the second, third and fourth options.

Second, they can select an actual application from a Code Repository, which uses a pre-packaged software component to transact with the application, and information model to describe the information they can transact.

Third, they can specify that one or more internal or external suppliers build a custom application not currently provided by the System, from scratch.

Fourth, they can create an application element corresponding to an existing ‘legacy’ application they already have running in their business and define access parameters etc. for that application.

When selecting an Application, the User can specify how they will transact information with the application. By default, the system applies simple default rules for each element of the applications' information model to ensure all information exchanged with that application is stored in the Semantic Graph TripleStore, and the user can amend these rules to suit their business model e.g. ‘Customer’ is updated every hour; ‘Purchase Order’ is pulled into the Graph every time a new order is created. Alternatively, they can use the Design Activities and/or Design Algorithm step to specify more complex rules and workflow steps for how information is transacted with Applications.

### 6. Design Information

The user designs the Information element 526 of their business model by specifying the information classes that the business model must manage. The System provides a window allowing the user to select pre-built ‘fragments’ or subsets of common business information from business models (e.g. Customer, Product, Order) from an Artefact Repository. This saves the user from having to re-create this common information and instead concentrate on the portions of the design of their business model that are unique and differentiating.

The interface provided to the users includes options to specify the classes, their relationships to other classes, data properties for classes, constraints (or restrictions) on classes such as allowable values and meaning for different types of information. Once created, the user can associate information elements to other elements of the business model design, such as information used as input into processes, algorithms, or applications. They can also select information classes and relationships they wish to analyse in order to assess the performance of their business model.

### 7. Design App Mapping

The user designs the Application Mapping element 527 of their business model by specifying through a user interface the mapping between information provided by an application, and the Information element of the business model design. This step is used to integrate data and information from legacy systems and databases that do not have pre-built information schema and application integration code provided via Step 5.

Using the Design Algorithms and Design Activities interfaces, they can also specify rules and workflow steps for automated processing of mapped information from source applications to the destination target business model design. All information classes defined in these mappings are in turn linked to the Information element of the business model, such that if these classes are changed, the system can re-compute the mappings.

### Build Phase

### 8. Create Ontology & Constraints

As the user creates their business model, the system creates 531 an Ontology, or knowledge representation, of the business model that conforms to the Ontology Web Language standard (see www.w3.org/TR/owl-syntax/). This ontology is stored and updated continuously, into the Business Model Repository, as the user creates their business model. This step occurs iteratively across steps 1 through 7, so the ontology is dynamic and evolves as the user designs their business model.

### 9. Build Schema

As the Ontology and Constraints are dynamically updated into the Business Model Repository, a Schema Manager software component takes these and builds 532 a set of ‘schema’ information structures that are consumed by other software components in the system to provide additional services that are responsible for building and operating the business model.

Schema created by this service include the following:
Environment Schema—describes how the business model is built onto computing and network hardware provided by an infrastructure-as-a-service cloud provider
Information Schema—describes the information that flows through activities, applications and algorithms; and how information will be stored by the Semantic Graph TripleStore semantic graph database. This allows for managing changing definitions of information in the business model, and the storage of this, linking of other disparate changing information, rapid evolution of the schema, and machine reasoning to derive new knowledge from the existing schema and stored information. It also includes an internal analytics information schema that allows users to define, save and display their own ‘analytics model’ representations of integrated data via sub-selections from the Information Schema. This is achieved through selection of available classes, relationships and common aggregation operations (e.g. time series, count etc), and associating these with one or more of the pre-packaged visual display techniques.
Constraints Schema—describes constraints (such as cardinality, set membership criteria, presence of data values, datatypes etc) that apply to all information. The allowable set of constraints is written by the system using the SHACL specification (www.w3.org/TR/shacl/), and these are checked during the Design, Build and Operate phases by the Rules Service, which calls the Constraints Service to check that constraints comply with this specification.
Workflow Schema—describes orchestrated sets of activities, which are used to exchange messages between applications and users, and which in turn conform to the Information and Constraints schema. This schema is expressed in the WS-BPEL 2.0 language (docs.oasis-open.org/wsbpel/2.0/OS/wsbpel-v2.0-OS.html)
Application Schema—describes the information structures managed by Applications and the corresponding integration code required to transact this information from the system to the application; these schemas and corresponding integration code are pre-built and provided in the system, and written using the RDF 1.1 standard and Java programming language, respectively
Integration Schema—describes how information integrated from applications is mapped into the form specified by the Information Schema. This schema is created by the User using the User Interface to map equivalent entities from the Application Schema to the Information Schema, and link any required rules via the workflow schema and algorithm schema. It may also be pre-defined for known application schema, to provide pre-built integrations
Algorithm Schema—describes algorithms and their required information input and output using one or more algorithm languages such as the R programming language (www.r-project.org/), and the Rule Interchange Format standard (www.w3.org/TR/rif-overview/)

### 10. Build Cloud Environment

A Deployment Manager software component takes the Environment Schema and builds 533 the network and server hardware and configurations required to operate the business model on computer hardware. These are built in a cloud Infrastructure-as-a-Service provider, such as Amazon Web Services.

The Deployment Manager may also call the Update Service (e.g. by being triggered from steps 11 and 13), to discover what pieces of software code and their respective versions, are required to be deployed onto this hardware. This component in turn calls a Version Manager to discover the correct version, and an Impact Analyzer, to understand any dependencies between the different versions to be deployed across the different cloud hardware environments. Once deployment is complete, this component then stores the actual as-deployed environment configuration into the Environment Registry.

### 11. Build Graph Database

Step 10 establishes the correct hardware to run the Graph Database component, but not the actual data to put into the graph. In this step 534, the Deployment Manager retrieves the Information Schema and Constraints Schema and applies them to the graph database to construct it. At this point the database is ready to start ingesting and storing business information in the form specified by the business model.

### 12. Build Activity Workflow

A Workflow Manager component takes the Workflow Schema, which is comprised of the set of linked Activities from the Business Model and constructs 535 an executable process model that defines information flows between Business Users, Applications (including the Graph Database) and Algorithms, and what to do when exceptions and errors are encountered in these flows. To support a wide range of Applications, the Workflow Manager is designed to support a range of different standard WS-BPEL Endpoints via common technologies and protocols, such as Web Services, REST API's, Graph endpoints, and SPARQL endpoints.

### 13. Build App Integrations

The Integration Manager component takes the Application Schema and extracts an identifier that specifies the name and version of the application to be integrated. It then uses this to query the Artefact Registry to discover the Information Schema and Integration Schema for that application and queries the Service Registry to discover the reference to the software component that will be used to integrate the application(s). Using this reference, it consults the Code Repository for the actual computer software integration code required to transact with the application and instructs 536 the Deployment Manager to deploy that software component into the Cloud Environment, using the method described in Step 10. It also provides to the Build Interface the Integration Schema to allow the user to map between this schema and the Information Schema.

### 14. Integrate Application Data

Once the appropriate software components are deployed to the Cloud Environment, the system triggers the default and/or user assigned rules and activities (defined in Steps 3 and 5) to transact information 537 with the integrated Applications. It also uses the retrieved Integration Schema to run the Application Mappings.

All information flows are checked to ensure they conform to the Information Schema and Constraints Schema, and hence to the design of the business model. All information integrated from applications is stored in the Semantic Graph Triple Store to preserve information in the event of applications becoming unavailable or being swapped for different applications. If an Analytics Information Schema exists, the system will process all inbound data and additionally conform this to the Analytics Information Schema.

### 15. Build Algorithms

The Integration Manager component takes the Algorithm Schema and extracts an identifier that specifies the name and version of the algorithm to be deployed. It then uses this to query the Artefact Registry to discover the Information Schema for that algorithm and queries the Service Registry to discover the reference to the software component that will be used to run the algorithm. Using this reference, it consults the Code Repository for the actual computer software code required to run the algorithm and instructs the Deployment Manager to deploy 538 that software component into the Cloud Environment, using the method described in Step 10.

### Operate Phase

### 16. Display Business Dashboard

Once the Design and Build phases are complete, the system provides an Operate Interface 541 to users. This user interface is responsible for showing a dashboard of the state of the executing business model. By default, it displays the business model elements (applications, activities, information, algorithms and business users), as they were drawn by the user in the Design phase. The current running operational state of each element is indicated by attributes such as numbers/sizes of each element (e.g. numbers of users, size of stored information), whether the element is functioning correctly (e.g. if an application has stopped transacting), when the element last changed (e.g. when a Customer record was updated) etc.

The Operate Interface accesses the Operations Manager component, which collects data on the operation of the business model from the running software in the Cloud Provider. This component exposes software instrumentation to allow for live data capture of the state of each piece of deployed software. The state information that can be reported in the Operate Interface can therefore encompass all information that the deployed software can expose.

The user is also presented with options to modify what they see in the Operate Interface, either by hiding or removing one or more of the business model elements, or by selecting or deselecting the state information that describe the operational state of the business model elements.

### 17. Display Environment Configurations

The Operate Interface also displays an interface 542 consisting of the state of the hardware and software environments provisioned by the Cloud Provider. These are grouped into one or more logical environments, defined by their logical purpose. For example: Development (to develop new aspects of the business model), Test (to test the new model), Quality Assurance (to ensure quality of the new model), and Production (to put it into live use by customers).

For each environment, the Operate Interface also displays the different software components deployed to that environment, and the versions of each component. An option is presented in the interface to automatically subscribe to new versions of each component (either for all components, or for individually selected components), or to request an update when the environment is notified that a new version of the component exists.

### 18. Display Data Flows

The Operate Interface also displays a graphical (pictorial) interface consisting of the different data flows 543, grouped by the classes defined in the Information Schema. For example, if a user has defined a Customer class, the Operate Interface will show how information corresponding to that class flows throughout the environments and is stored into the Semantic Graph TripleStore.

### 19. Display Data Summaries

The Operate Interface also displays 544 an interface consisting of a tabular representation of the information schema and instance data stored against that schema. Each class in the schema is available to be selected, and once selected, the actual instance data stored for that class is displayed in rows along with the relationships to other classes, data properties, constraints, and any other information captured in the Information Schema. Pre-built summaries are also shown for each class, such as counts. If an Analytics Information Schema has been created, the Operate Interface displays any information stored in the Semantic Graph TripleStore as it conforms to the specification of the Analytics Information Schema.

A variety of visual display techniques are provided by default by the system for the different steps in the Operate phase, such as line graphs, time series graphs, scatter plots, histograms, area charts, geospatial overlays, etc.

### Implementation Mechanism

FIG. 6, 601, depicts the system implementation mechanism necessary to design 602, build 603 and operate 604 an Ontological Driven Executable Business Model for a user.

This implementation mechanism provides a technical system to capture and manage the ontologies and schema, deployment configuration and runtime metrics for the business model, and utilizes a Software tool running on physical computing system hardware.

The following describes the internal software and hardware components comprising this implementation mechanism.

Design Interface 602—responsible for providing an interface to design the business model.

Build Interface 603—responsible for providing an interface to build executable aspects of the business model.

Operate Interface 604—responsible for providing an interface to operate the executable business model.

Schema Manager 605—responsible for creating and updating a set of information structures (schema) that are consumed by other software components in the system, which in turn provide additional services that are responsible for building and operating the business model. Each schema is stored into the Business Model Repository component.

Library Manager 606—responsible for managing access from the Design and Build interfaces to different artefacts and services stored in the Artefact Registry and Service Registry.

Workflow Manager 607—responsible for creating executable orchestrations of activities that interact with other business model elements.

Integration Manager 608—responsible for providing services to the Build Interface to connect to external applications, map between these external information structures and the information schema, and define routings of data between integrated systems and the Semantic Graph TripleStore. This component collaborates with the Deployment Manager to deploy the integrations, the Artefact Registry and Service Registry, and the Code Repository to provide it with schemas and mappings. It achieves these outcomes by calling one or more sub-components to connect, map and transform data from different types of external and internal systems such as API's, queue managers, databases and Apps, and the Semantic Graph TripleStore.

Operations Manager 609—responsible for providing services to the Operate Interface, to report on the operational performance of the business model.

Rules Manager 610—responsible for providing services to manage rules as part of the Activity business model element. This component supports a ‘pluggable’ approach which allows it to plug in one or more rules engines. It also collaborates with other components to check and validate rules, information schema and constraints via the Reasoner Service component and Constraint Service component, and to manage activities via the Rules Service.

Algorithm Manager 611—responsible for providing services to manage algorithms. This component supports a ‘pluggable’ approach which allows it to plug in one or more algorithm languages via additional components. The default provided language is the R statistical programming language and RIF rule interchange format language.

Version Manager 612—responsible for providing versioning services to all the system software components and schema/ontologies managed by the system. This allows the system to manage multiple versions of these over time, including deployment to the Cloud Provider, and roll back currently deployed schema and software components as needed.

Reasoner Service 613—responsible for providing services to validate ontologies/information schema, and for inferring new knowledge from existing knowledge/information stored in the Business Model Repository and customer Graph database. This component supports a ‘pluggable’ approach which allows it to plug in one or more Reasoners depending on performance and user need.

Constraints Service 614—responsible for providing services to validate constraints applied against the information schema. This component supports a ‘pluggable’ approach which allows it to plug in one or more SHACL-compliant software components, depending on performance and user need.

Rules Service 615—responsible for providing services to create and validate activities and their assembly into processes in conformance with the BPEL specification.

Impact Analyzer 616—responsible for providing services to analyse the impact of changes in versions of schema, such as changes to an ontology or changes to deployed software.

Update Service 617—responsible for providing services to manage updating of deployed software components and schema across the Cloud Provider Environments.

Deployment Manager 618—responsible for providing services to deploy software components and schema, and any other associated configurations, to the Cloud Provider Environments.

Business Model Repository 619—responsible for storing, updating and providing the different constituent parts of the executable business model. This repository is an instance of the underlying Semantic Graph Triplestore component.

Artefact Registry 620—responsible for providing services to store, update and manage a registry of artefacts used by the system, including schema and configuration data. This repository is an instance of the underlying Semantic Graph Triplestore component.

Service Registry 621—responsible for providing services to store, update and manage a registry of software components used by the system model including their names, versions and locations in the Code Repository. This repository is an instance of the underlying Semantic Graph Triplestore component.

Code Repository 622—responsible for providing services to store, update and manage the actual code for the software components used by the system. This repository is provided via one or more storage technologies such as file system-based storage (e.g. Amazon S3).

Environment Registry 623—responsible for providing services to store, update and manage the description of the Cloud Provider Environments used by the system to operate the system infrastructure, code and schema, and by end-user operational business models created, built and operated using the system. This repository is an instance of the underlying Semantic Graph Triplestore component.

Semantic Graph TripleStore 624—responsible for providing database management services that are compliant with Semantic Web specifications, including RDF version 1.1 (www.w3.org/TR/rdf11-concepts/) for structured data, SPARQL version 1.1 (www.w3.org/TR/sparql11-overview/) for graph data access and update management.

Cloud Provider Environments 625—responsible for providing ubiquitous access to shared pools of configurable system resources and higher-level services that can be rapidly provisioned with minimal management effort, consisting of the physical computer hardware and networking hardware required to run the software components described above for the system, provisioned and managed by a Cloud Service Provider such as Amazon Web Services.

Insight Manager 626—responsible for providing services to create aggregate summaries of data stored in the Semantic Graph TripleStore. This component uses Analytics Information Schema to define aggregate instances of classes detailed in this schema, and store this summary data in a separate named graph within the Semantic Graph TripleStore.

It may call upon other components in the process of creating and storing aggregate summary data. These include calling the Integration Manager, to perform transformation operations on stored instance data, and the Schema Manager, to classify ingested data into categories suitable for aggregation, according to specific information definitions in the Analytics Information Schema. It may also use the Integration Manager to ship the instance data conforming to these Analytics Information Schema, to other external databases and application programming interfaces for external analysis.

Transformation Service 627—provides services for transforming data from source to destination based on mappings between the Information Schema, Integration Schema, and Application Schema.

Endpoint Service 628—library of code stored in repository for talking to App's, API's, DB's etc to create, read, update and delete data from these endpoints.

Queue Service 629—manages connections to off-the-shelf queue systems, used to access and propagate data between Apps.

The methods and systems described may be utilised on any suitable electronic computing system. According to the embodiments described below, an electronic computing system utilises the methodology of the invention using various modules and engines.

The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium.

The electronic computing system is arranged to be in communication with data storage systems or devices (for example, external data storage systems or devices) in order to retrieve the relevant data.

It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

An example implementation will now be described, the example implementation is not meant to be limited but provides an example of how the system could be implement and used.

‘EvilBank’ wishes to evolve its business model to become a ‘full service’ bank by offering products and services outside of its core transaction savings and loans account products. They aim to achieve this by buying and integrating an Insurance company ‘InsuranceCorp’ and an external service that provides car crash data, to extend their existing banking products and up-sell new insurance products.

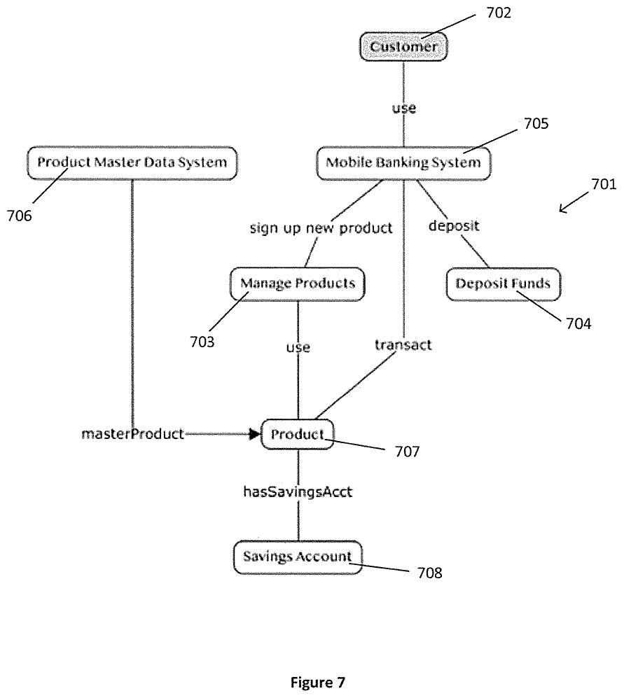

In this example, the flow 701 is as illustrated in FIG. 7 and are indicative only; other flows may be utilised.

### Design Phase

This is step 1 Access Business Design Tool, discussed above.
1. EvilBank accesses the Business Design Tool and loads their Business Model, which in the example shown in FIG. 7, shows the system framework elements as follows: Business Role 702, Activity 703, 704, Asset including Algorithms (not shown here) and Apps 705, 706, Information 707, 708, and Relationships the lines connecting these all together.

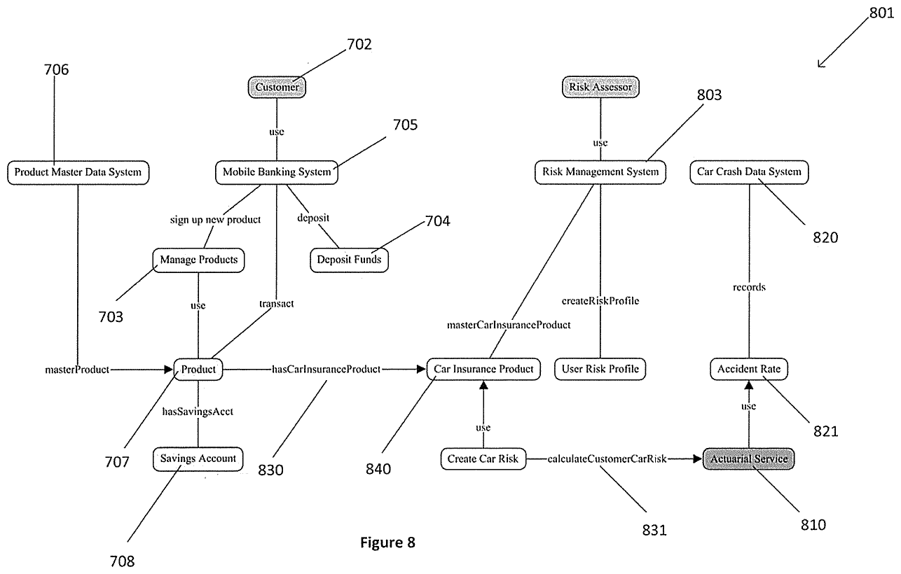

Here, the business model includes a Customer 702 (Business Role) accessing a Mobile Banking System 705 (Asset/Application) to manage products 703 (Activity) such as signing up for new products 707 (Information), which are maintained in a Product Master Data System 706 (Asset/Application), and deposit funds 704 (Activity from an existing Savings Account product 708 (Information). The EvilBank Product Master Data System is responsible for mastering data for all Products offered by the bank. Customer was previously created by selecting the pre-packaged “Customer” mini-ontology from the Library Manager component and dragging it onto their canvas as they built their business model.
2. Once InsuranceCorp has been integrated into EvilBank, the Business Model is updated to include the business model elements from InsuranceCorp which will allow EvilBank to sell a Car insurance product offered by InsuranceCorp but augmented with additional crash data to give a more accurate risk assessment and hence higher profitability. FIG. 8 depicts how the new business model 801 might look.
3. A new Risk Assessor Business Role is added
4. A new Application (Asset) is added to the business model for the Risk Management System 803 (application). This app masters a set of insurance products that the bank wishes to add to its products and was developed privately by InsuranceCorp. Therefore, there is no pre-built integration for it in the system, so the system asks the user for connection and authentication parameters in order to transact with the app. Because they only want to use the products mastered by this app, the user enters a URL and database connection string for the Risk Management System database
5. A new Application (Asset) is added to the business model for the Car Crash Data System 820, a public third party external system. This app records Accident Rates 821 (information) for individuals making insurance claims. Because it is a commonly used public app, it has been pre-integrated into the system, so the user drags an icon for it onto their business model, from the pre-built library of model integrations. The system asks the user for parameters to allow it to connect to the application, so the user enters the app URL and password.
6. The user now wishes to augment the Car Insurance Product information with additional risk data from the Car Crash Data System. The user adds a blank algorithm icon to their business model and names it “Actuarial Service” 810, then writes the algorithm rules in the system design interface according to the syntax provided by the system editor (here, the DROOLS rule syntax). They calculate a new risk factor called CarAccidentRisk to calculate 831 a risk profile based on a threshold of number of accidents in the current year, and get the accident rate data by calling the Car Crash Data System using the user supplied connection parameters, as shown in this example:

```
rule ″calculate CarAccidentRisk″
  when Accident_Rate > 2 and get ″Accident_Rate″ from:
  CarCrashDataSystem/getAccidentRate
  and year=currentyear
  then Risk Profile=′high′
end
```

7. The user then links the output of this algorithm to a new activity they create, which will take this new risk profile data and use it to update the Risk Management System database. This activity is created in the system design interface according to the syntax provided by the system editor (the BPMN activity syntax). This is a standard activity/workflow language, and not shown here for brevity.
8. To bring this new data into the Bank, the user specifies a new relationship 830 from Product to Car Insurance Product 840, and the system provides an interface showing the source Car Insurance Product information classes, relationships and data properties, the target Product information classes, relationships and data properties, and allows the user to draw lines that map from source to target, and if required, any rules to add business logic to transform the format en-route (e.g. change “Name” to “Customer Name”. The system provides a built-in set of business logic functions that can be chained together to achieve this logic e.g. Starts With, Ends With, Contains, >, +, =, Not etc
9. New relationships are added to the system model for EvilBank, InsuranceCorp and the third-party Car Crash service provider as shown above by the lines connecting the elements of the business model.

### Build Phase

This is step 9 Build Schema, discussed above.
1. The system editor component takes the user inputs in the Design phase and for each business model element and relationship, it constructs an ontology in RDF format as sets of Triples, as shown in this snippet below and in Table 2.

```
<owl:Class rdf:about=″EviBank#Savings_Account″>
    <rdfs:subClassOf rdf:resource=″EviBank#Product″/>
  </owl:Class>
```

TABLE 2
Ontology RDF Triples

| Subject | Predicate | Object |
|---|---|---|
| Savings Account | SubClassOf | Product |

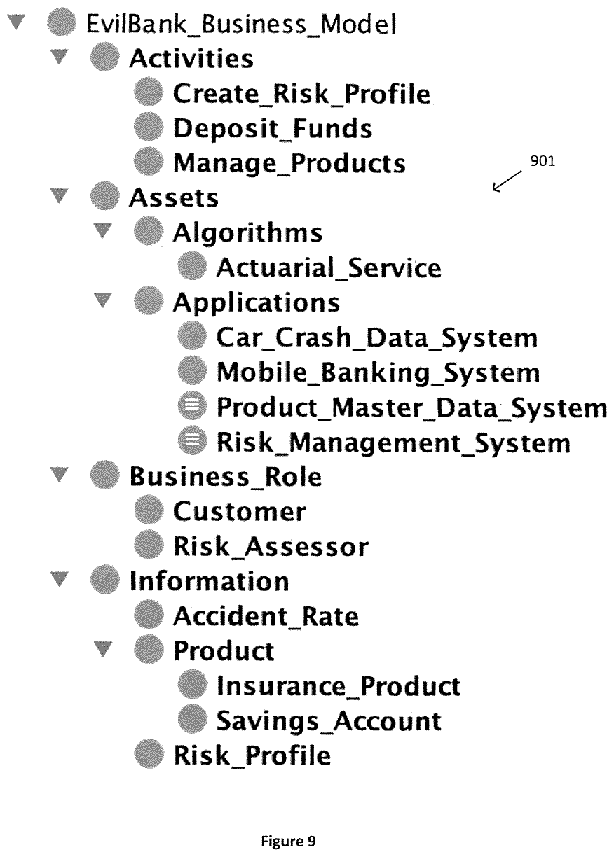

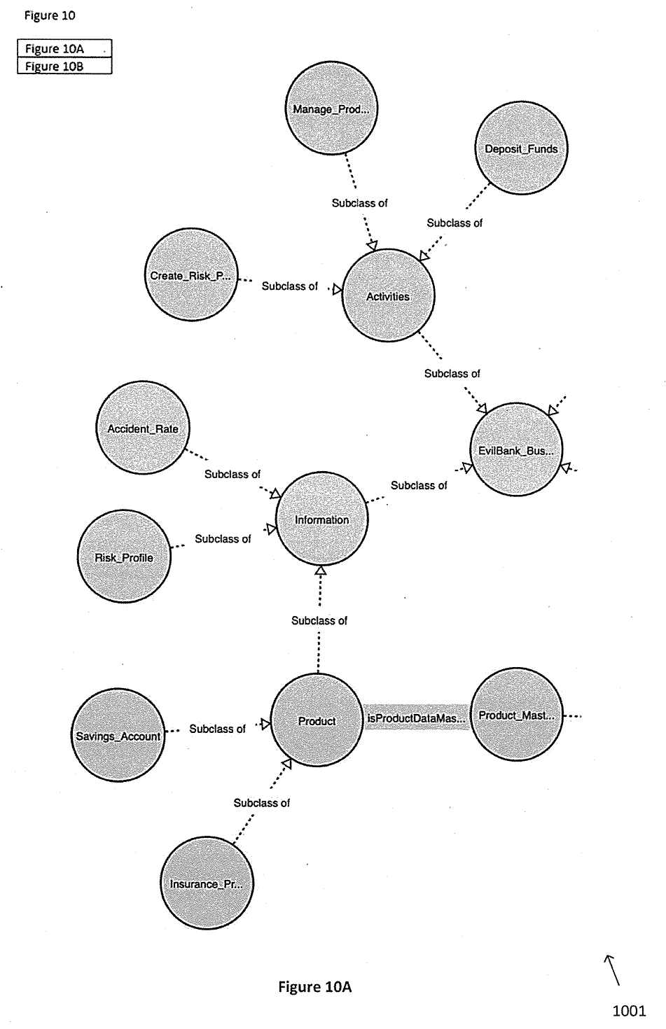

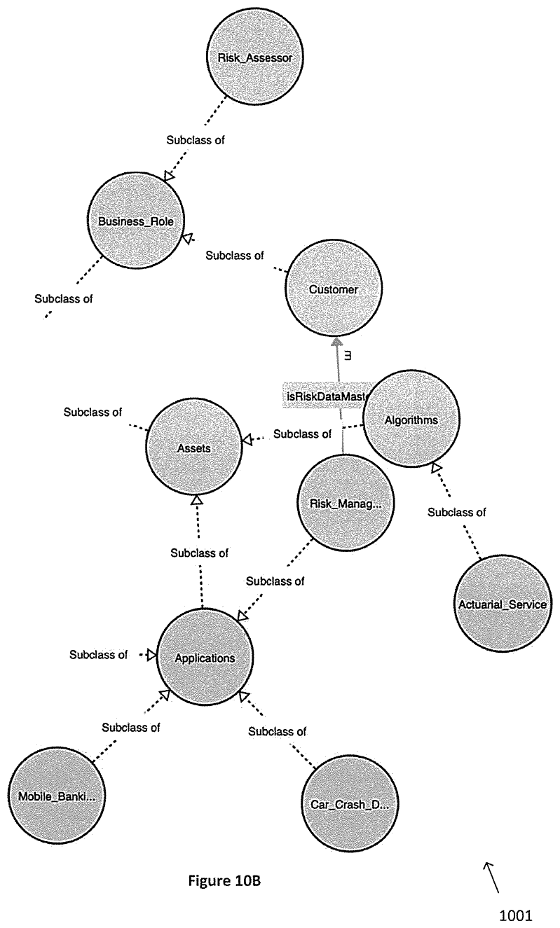

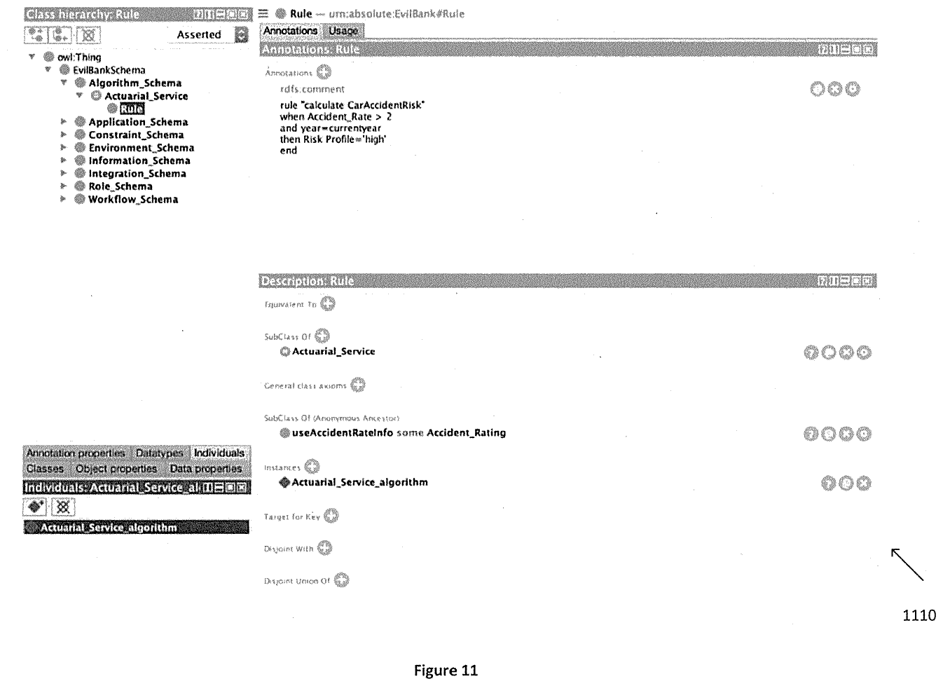

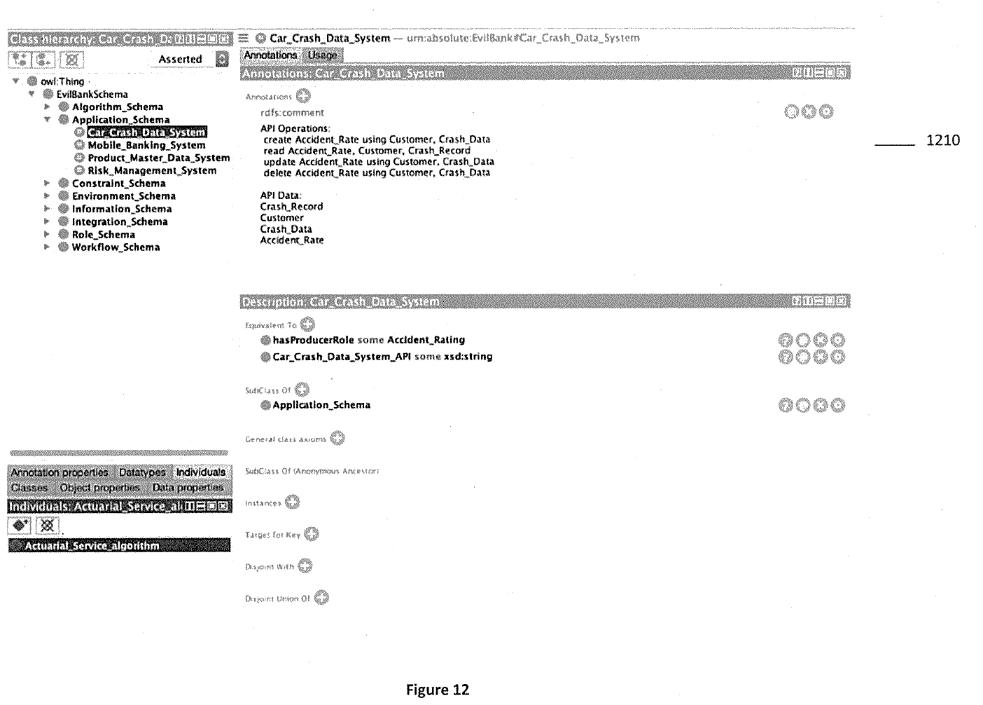

Here, a ‘Savings Account’ is a Sub class of Product and the new Evil Bank ontology 901 would resemble the diagram illustrated in FIG. 9, depicting the EvilCorp business model grouped into the business model framework elements, and alternatively as FIG. 10, depicting the same business model as an information-centric graph view 1001.
2. The Schema Manager takes this Ontology and using a set of rules encoded in the Java business logic of this service, converts the Ontology into different information structures (known as schema) that are used by other platform components. These rules partition the different business model elements into separate schema-per-element and add the customer-specific data into slots provided in the schema templates managed by the system.
   Algorithm Schema—this schema specifies the how the algorithms created in the Business Model ontology will be used once the business model has been deployed into the Cloud Provider Environment. The Schema Manager creates this schema by extracting each algorithm definition (set of rules) from the ontology, encoding them into a structured text file along with a customer identifier, a unique identifying key for each algorithm, relationships between to the information and activities the algorithms will interact with from the other schema, a reference to the software component to run the algorithm stored in the Service Registry, and a version number. The Schema Manager then stores this file into the Artefact Registry.
      FIG. 11, 1110 illustrates how the Schema Manager has extracted the Actuarial Service algorithm from the Ontology and packaged it into the Algorithm Schema.
   Application Schema—this schema specifies how the applications defined in the Business Model ontology will be used once the business model has been deployed into the Cloud Provider Environment. The Schema Manager creates this schema by extracting the defined applications from the Ontology and encoding them into a structured text file, along with a customer identifier, a unique key identifying each application in the Service Registry, a reference to the corresponding system integration code stored in the Code Repository (for the public apps with a system-provided integration), accompanying application information schema (specifying data and operations to transact), entries in the Workflow Schema for accessing the app independently from the API/Data specification, and a version number.
      For ‘private’ applications that are not in the repository, it includes entries for the connection and authentication parameters required to transact with the applications. The Schema Manager then stores this file into the Artefact Registry.
      FIG. 12 illustrates how the Schema Manager has extracted the Car Crash Data System application from the Ontology and packaged it into the Application Schema. It also shows the API operations and Data 1210 that the app can transact (pulled from the Code Repository).
   In this example, the application schema first assembles data for the four applications selected by the user in their business model. The Car Crash Data System is shown, which was selected as having the ‘ProducerRole’ for Accident_Rate data i.e. this system is the authoritative source of this data.

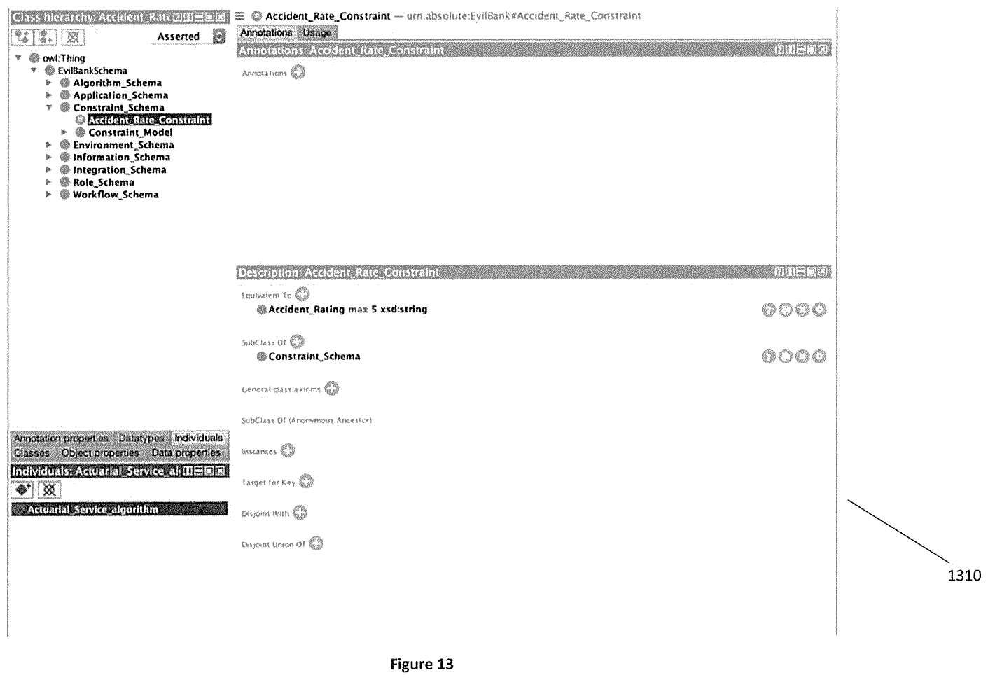

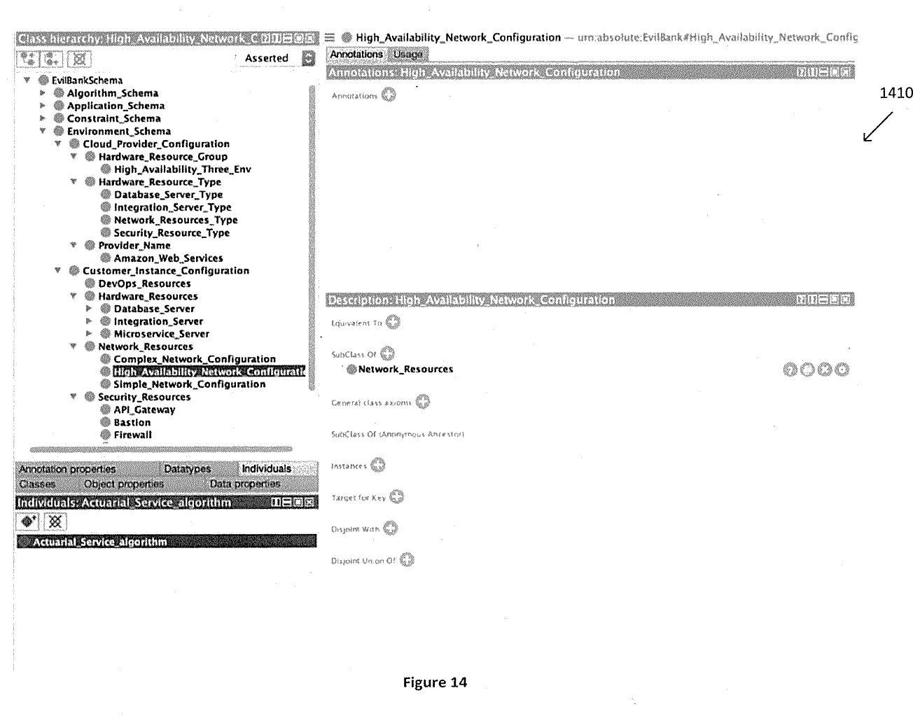

This application provides a public API (or programmatic contract) that specifies what data is transacted via defined ‘operations’ (i.e. the work the application will do on the data), as seen in the annotations box above. These API definitions are stored in the system Code Repository and surfaced in this interface.
Once this schema is created, the Schema Manager also modifies entries in several other schema as follows:
Information Schema
   Adds a Producer relationship link between the Accident_Rate class to Car Crash Data System.
   Adds additional class entries for the other API data class this application requires.
      Crash Data
      Customer
      Crash Record
   These schema changes allow system components to discover the right application if they query for the source of Accident_Rate data e.g. when they need to run data ingestion and transformations to pull across and store the changed Accident_Rate data. The other entries allow the system to store this data if required at a later date.
Application schema
   Adds a Producer master data tag to this application
   Adds relationships for each operation in the application API to their corresponding information classes:
      create Accident_Rate->Customer
      create Accident_Rate->Crash_Data
      read->Accident_Rate
      read->Crash_Record
      read->Customer
      update Accident_Rate->Crash_Data
      update Accident_Rate->Customer
      delete Accident_Rate->Crash_Data
      delete Accident_Rate->Customer
   These schema changes allow the system components to discover produced information if they query the Car Crash Data System application. The other entries allow further discovery of what operations are supported by this application, and the data they require to function.
Workflow Schema
   Adds activity for each Application API operation
      create Accident_Rate
      read Accident_Rate
      read Crash_Record
      read Customer
      update Accident_Rate
      delete Accident_Rate
   These schema changes provide a customisable set of executable BPEL process models that allow the user to interact with the information flows in a human-readable format that they can subsequently modify if needed. It also allows third party components to modify the information flow without impacting the original application or needing to understand the original API.
Now, when an application requests (‘read’ operation) Accident_Rate data for a Customer, the system looks up the Information Class Accident_Rate from the Information Schema, finds these are Produced by the Car Crash Data System which also requires the class Customer to run the Read operation, find the correct Activity for Read (Accident_Rate), runs this activity which in turn synchronises the data held in the EvilBank business model repository via an API call to the responsible Producer system API defined in the application schema.
Constraints Schema—this schema specifies how the constraints created in the Business Model ontology will be used once the business model has been deployed into the Cloud Provider Environment. The Schema Manager creates this schema by extracting each constraint definition from the ontology, encoding them into a structured text file using the SHACL constraint language, along with a customer identifier, a unique identifying key for each constraint, and relationships referring to the constraint and information classes it applies to, and a version number. The Schema Manager then stores this file into the Artefact Registry.
   In this example, constraints were set during the Design phase using the Business Design Tool. The user created the Accident_Rating Information entry in the Business Design Tool and specified that there could be a maximum of 5 entries. This is processed into a constraint 1310 of 5 applied to Accident_Rating, as shown in FIG. 13 as “Accident_Rate max 5 xsd:string”.
Environment Schema—this schema specifies how the business model elements are deployed into and executed by the Cloud Provider Environment. The Schema Manager creates this schema by extracting each entry from the artefact registry and code registry for a customer, encoding them into a structured text file along with a customer identifier, a unique identifying key for each element in that customers business model, relationships between the elements, and a version number. This file is formatted by the Schema Manager into a structure specified by the Cloud Provider control language (e.g. Amazon Web Services Cloud Formation templates) and specifies the following elements:
   Cloud Provider Configuration—the generic environment configuration elements required to build and deploy a business model to a given cloud provider, including:
      Hardware_Resource_Type—the hardware resources required to run different software components of the system platform e.g. in this example, four resource types are shown including the Database_Server_Type required to run the EvilCorpGraphDatabase
      Hardware_Resource_Group—groupings of different types of hardware resources to achieve different purposes e.g. ‘high availability’ for a cloud environment that can operate continuously in the event of outages and problems such as lost network connections. Shown here is a High_Availability_Three_Env group, which specifies high availability and three environments (development, testing, production)
      Provider_Name—the cloud provider name and default connection and account details to begin working with that provider
   Customer Instance Configuration—the customer specific business model elements that need to be deployed onto the cloud provider environment, including:
      Dev_Ops Resources—specifies software components required to manage, build, test, and deploy customer-written code (if required) into the cloud provider. These elements are typed and grouped to allow deployment of these components across the different parts of the cloud environment
      Hardware Resources—the actual customer instances of business logic/components, such as application integrations, algorithms, and workflows, placed into the hardware resource types specified in the Cloud Provider Configuration. In this example, the EvilCorpGraphDatabase is categorised into the Database_Server Hardware_Resources
      Network Resources—the network configuration selected fort the given business model. This is defined by the user as operational performance attributes, when they create their business e.g. the user can select options in Design to specify “simple, low volume business”, or “always-on business”. The system Design interface adds entries in the customer ontology corresponding to these e.g. High_Availability_Network_Configuration for “always-on”
      Security Resources—The design interface also adds security entries based on the user input for required security systems such as firewalls
   In our example, the EvilBank Environment Schema includes additional entries that for instances required including Database_Server, Integration_Server and Microservice_Server configurations. In the latter case the Schema Manager reads that the Car Crash Data System, a pre-packaged application, has been selected by the user, so it creates an entry in the Microservice_Server category that specifies a type of hardware server will be created at the Cloud Provider to run the Java business logic necessary to transact with the API this system provides. Once this schema is created, it is passed to the Deployment Manager software component for execution as illustrated 1410 in FIG. 14.
Information Schema—this schema specifies how the information created in the Business Model ontology will be stored and managed in the EvilBank Graph Database that will be deployed into the Cloud Provider Environment. The Schema Manager creates this schema by extracting each information class from the ontology, encoding them into a structured text file using the RDF format, along with a customer identifier, a unique identifying key for each class of information, and relationships referring to the other information classes, and a version number. The Schema Manager also adds default entries into the Application Schema for a customer Graph Database to store all information. The Schema Manager then stores this file into the Artefact Registry.

When changes are made to the schema, the Version Manager, and Impact Analyzer are notified to query the version, any dependent artefacts or code in other registries, assess the impact of the change, and either notify the user of success or failure of the change based on impact. If the change is non-breaking (i.e. a change will not impact other schema) then the Schema Manager notifies other system platform components to read this schema and use it to inform their operation. For example, if EvilBank change the definition of Customer to include new attributes, the Integration Manager and Workflow Manager can be notified that they can now use those new attributes.

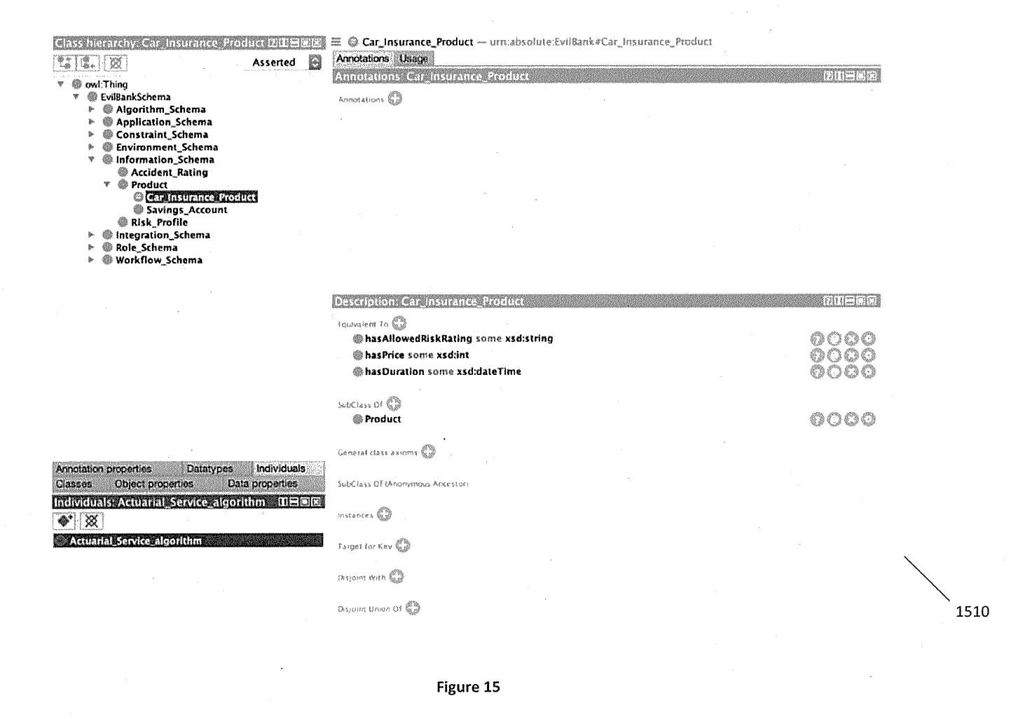

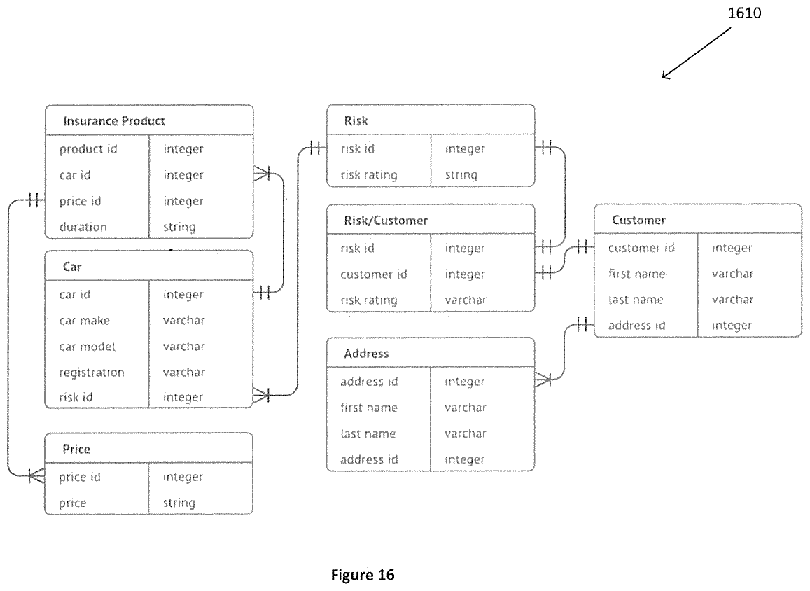

In our example, the Car_Insurance_Product Information entity has been selected, displaying attributes for that entity including the allowed risk rating, price, and duration of the product offering. As illustrated in FIG. 15 these will be stored in the EvilBank Graph Database in RDF format according to this schema 1510.
Integration Schema—this schema specifies how information can be manually integrated from producer and consumer systems. The Schema Manager creates this schema by reading the producer and consumer classes linked together by the user, and creating a corresponding TransformationMapping file, to which is added a customer identifier, a unique identifying key for each transformation map, and relationships referring to the different information classes, and a version number. The Schema Manager then stores this file into the Artefact Registry, and the Integration Manager notified of the new schema (once it passes version/impact testing by the system—see above).
   In our example, the User linked the Car Insurance Product information entity to the Product entity. The Schema Manager reads this relationship and creates a transformation-mapping file to transform the source relational database table structure into RDF graph data structures for storage in the graph database.
   The entity relationship diagram 1610 shown in FIG. 16 depicts the relational database managed by the Risk Management System. The Integration Manager reads from the Risk Management System database and converts it in a first pass into an RDF data representation of the relational tables, using the transformation mapping stored in the artifact registry. This conversion, shown in Table 3 below, takes each relational table and converts it to a RDF Subject, internal table columns with no keys become RDF data property object, and columns with primary/foreign keys become predicates between tables (subject to object mapping). Intersection tables such as Risk/Customer are also turned into predicates.

TABLE 3

| Database entity | RDF Subject | | |
|---|---|---|---|
| Table-Insurance | Insurance | | |
| Product | Product | RDF Predicate | RDF Object |
| Column-product id | | hasProductID (dp) | type xsd: integer |
| Column-car id | | HasCarID (op) | Car |
| Column-price id | | hasPriceID (op) | Price |
| Column-duration | | hasDuration (dp) | type xsd: string |

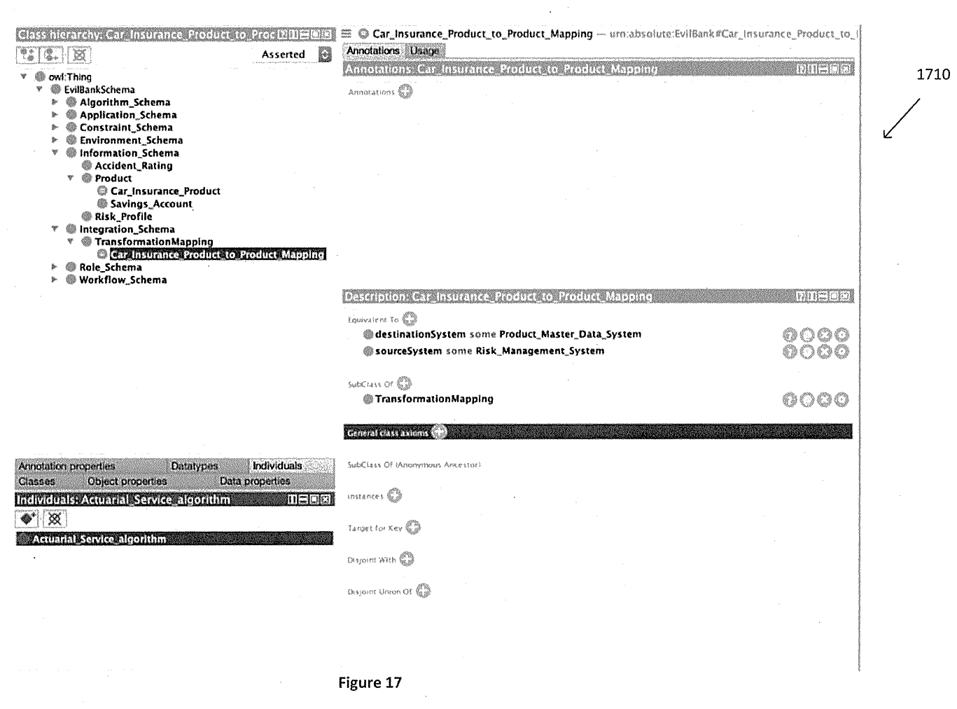

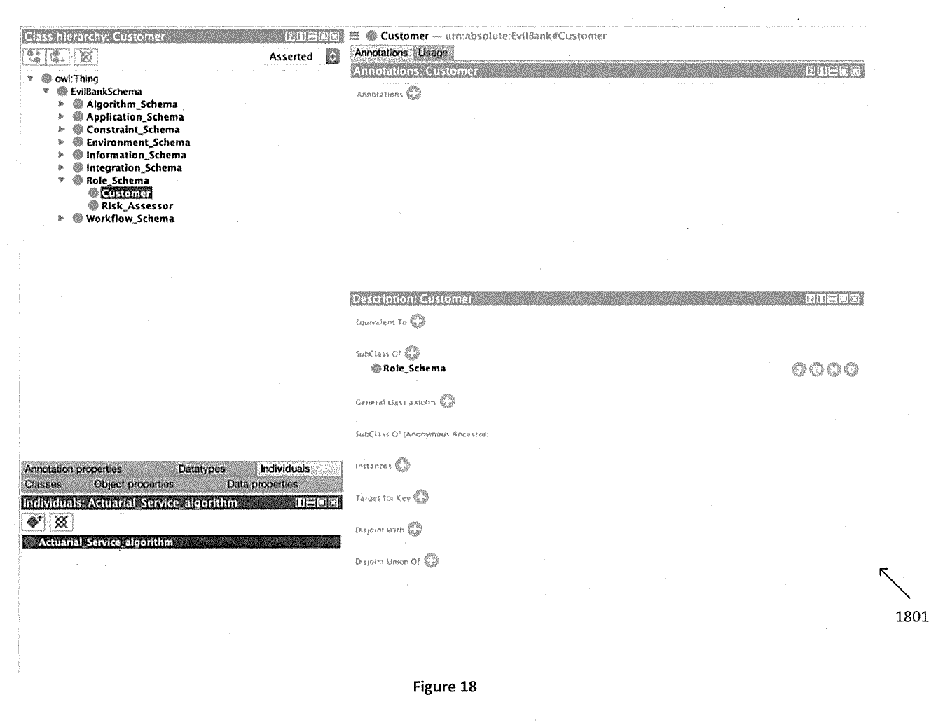

As seen in FIG. 17 further refinement of the data integration can occur via the user interface provided in the Design Integration Mapping step. For example, the Duration field from the relational database is not needed in this integration as duration of a product will be mastered in the existing EvilCorp Product Master Data System, therefore in mapping 1710 the user selects options to discard this information when the integration job runs.
Role Schema—this schema specifies how the roles created in the Business Model ontology will be used once the business model has been deployed into the Cloud Provider Environment, as illustrated 1801 in FIG. 18. The Schema Manager creates this schema by extracting each role definition from the ontology, encoding them into a structured text file using RDF format, along with a customer identifier, a unique identifying key for each role, and relationships referring to the activities, applications and information classes it applies to, and a version number. The Schema Manager then stores this file into the Artefact Registry.
   Each role can have additional parameters assigned to it by the user, that are used by the Environment Schema to control who is allowed to manage the customer's deployed Business Model.
   For example, the Risk Manager may be allowed to modify the Create Car Risk activity, as this activity is concerned with issues of risk. When the business model is deployed into the Cloud Provider Environment, any subsequent requests to make changes to this activity are passed to an Authentication Service provided by system, which checks the parameters of the request to ensure they comply with the Role defined as having edit rights to that activity.
Workflow Schema—this schema specifies how the activities created in the Business Model ontology will be used once the business model has been deployed into the Cloud Provider Environment. The Schema Manager creates this schema by extracting each activity and set of activities defined in the ontology and encoded in the BPEL format or alternatively added by the Schema Manager from other schema, adding with a customer identifier, a unique identifying key for each activity, and relationships referring to the applications and information the activities apply to, and a version number. The Schema Manager then stores this file into the Artefact Registry.
   Following completion of these schema, the user selects an option in the user interface to build their new EvilBank business model. This triggers Step 10: Build Cloud Environment and subsequent steps in the Build phase of the invention description.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of designing, building and operating a business model for a business on an electronic computing device comprising the steps of:
receiving and storing a plurality of elements including entities that participate in the business;
activities that are performed by users or applications;
assets of the business, including applications and algorithms,
wherein the application assets are linked with activities and information; and
algorithms that are linked with information; and
information to be accessed and processed by activities and assets;
receiving and storing links between the elements;
creating an ontology of the elements and links representative of the business model;
creating a plurality of schema representative of the business model, the plurality of schema including:
an information schema that describes the information that flows through the activities;
a constraints schema;
a workflow schema representative of the activities;
an application schema representative of the applications; and
an algorithm schema representative of business rules;
an environment schema;
an integration schema;
storing the plurality of schema in a graph database;
creating an activity workflow from the workflow schema;
creating application integrations using the information and application schemas;
creating a plurality of algorithms from the algorithm schema for the operation of the business model;
creating a declarative specification of these schema via deployment of hardware and software configurations
realising this specification through deployment into a cloud system
creating an operational interface and displaying the operational interface to allow a user to operate the business.

2. The method of claim 1 wherein the entities that participate in the business include business users, partners, suppliers, and participants in value chains/networks.

3. The method of claim 1 wherein activities include any arbitrarily complex business process, value chain, resource and/or capability definition as sets of manual and/or automated activities.

4. The method of claim 3 wherein activities create and consume information.

5. The method of claim 1 wherein the assets include physical and digital assets.

6. The method of claim 1 wherein digital assets provide automation to the business model through technology and include applications used to deliver the activities.

7. The method of claim 1 wherein algorithms provide user defined business rules to the business model through consumption, computation according to defined rules and resulting output of new information.

8. The method of claim 1 wherein the information has constraints which restricts the structure and meaning of information.

9. The method of claim 8 wherein the constraints are stored as information.

10. A system for designing, building and operating a business model for a business the system including:
at least one processor;
memory associated with the processor; and
a display device,
wherein the processor is programmed to perform the steps of:
receiving and storing a plurality of elements including
entities that participate in the business;
activities that are performed by users or applications;
assets of the business, wherein the assets are linked with activities; and
information to be accessed and processed by the assets and activities;
receiving and storing links between the elements;
creating an ontology of the elements and links representative of the business model;
creating a plurality of schema representative of the business model, the plurality of schema including:
an information schema that describes the information that flows through the activities;
a constraints schema;
a workflow schema representative of the activities;
an application schema representative of the applications; and
an algorithm schema representative of the business rules;
an environment schema representative of the physical deployment of the business model;
storing the plurality of schema in a graph database;
creating an activity workflow from the workflow schema;
creating application integrations using the information and application schemas and user defined mappings between these;
creating a plurality of algorithms from the algorithm schema for the business rules of the business model;
creating a physical deployment specification for the operation of the business model from the environment schema;
creating an operational interface and displaying the operational interface to allow a user to operate the business.

11. The system of claim 10 wherein the entities that participate in the business include business users, partners, suppliers, and participants in value chains/networks.

12. The system of claim 10 wherein activities include any arbitrarily complex business process, value chain, resource and/or capability definition as sets of manual and/or automated activities.

13. The system of claim 12 wherein activities create and consume information.

14. The system of claim 10 wherein the assets include physical and digital assets.

15. The system of claim 10 wherein digital assets provide automation to the business model through technology and include applications used to deliver the activities and algorithms used to compute business rules.

16. The system of claim 10 wherein the information has constraints which restricts the structure and meaning of an information.

17. The system of claim 16 wherein the constraints are stored as information.

18. The system of claim 10 wherein the physical network and server hardware resources required to operate the business are specified and controlled using a declarative specification and mapping of the business model elements onto common hardware and software systems.
